(19) United States
(12) Patent Application Publication
(10) Pub. No.: US 2016/0003686 A1
(43) Pub. Date: Jan. 7, 2016

(54) INTAKE AIR TEMPERATURE SENSOR AND FLOW MEASUREMENT DEVICE

(71) Applicant: HITACHI AUTOMOTIVE SYSTEMS, LTD., Ibaraki (JP)

(72) Inventors: Masahiro MATSUMOTO, Tokyo (JP); Hiroshi NAKANO, Tokyo (JP); Keiji HANZAWA, Hitachinaka (JP); Satoshi ASANO, Tokyo (JP)

(73) Assignee: HITACHI AUTOMOTIVE SYSTEMS, LTD., Hitachinaka-shi, Ibaraki (JP)

(21) Appl. No.: 14/647,031

(22) PCT Filed: Oct. 25, 2013
(86) PCT No.: PCT/JP2013/078899

§ 371 Date: Sep. 4, 2015

(30) Foreign Application Priority Data
Nov. 22, 2012 (JP) 2012-255830

(51) Int. Cl. G01K 7/25; G01K 13/02; G01K 15/00; G01F 1/696; G01F 25/00

(52) U.S. Cl. CPC G01K 7/25; G01F 1/6965; G01F 25/0007; G01K 15/005; G01K 13/02; G01K 2013/024

(57) ABSTRACT

An object of the present invention is to provide a compact and highly accurate intake air temperature sensor by integrating a fixed resistor, connected in series to a temperature sensing element, into an integrated circuit and dispensing with a reference resistor or a changeover switch for connecting the fixed resistor to this reference resistor. The intake air temperature sensor has a temperature sensing element whose resistance value varies with the intake temperature; an integrated circuit electrically connected to the temperature sensing element; a resistive element connected in series to the temperature sensing element; a writable memory that stores correction information corresponding to the resistance value of the resistive element; and a correction processing unit that corrects errors based on the resistance value of the resistive element, which are included in output signals of the temperature sensing element, on the basis of the correction information stored in the writable memory.

### TECHNICAL FIELD

The present invention relates to an intake air temperature sensor for detecting intake temperatures and a flow measurement device equipped with the intake air temperature sensor.

### BACKGROUND ART

Conventionally, a resistance value measuring device, an integrated circuit for resistance measurement and a resistance measuring method described in JP-A No. 2005-3596 (Patent Literature 1) are known.

In this resistance value measuring device, a thermistor whose resistance value varies with the temperature and a reference resistor having a highly accurate resistance value are disposed outside an IC (integrated circuit). The thermistor is connected to channel CH1 of an A/D converter provided within the IC, and the reference resistor is electrically connected to channel CHref of the A/D converter. On the way of electric wiring for connecting the thermistor to the channel CH1, a pull-up resistor R1 is connected via a switch SW1. On the way of electric wiring for connecting the reference resistor to channel CHref, electric wiring tapped from the connecting part between the switch SW1 and the pull-up resistor R1 is connected via a switch SW2. The pull-up resistor R1, the switch SW1 and the switch SW2 are disposed within the IC.

At normal times, the switch SW1 is on and the switch SW2 is off, and the voltage at the connection point between the switch SW1 and the thermistor is inputted to channel CH1 of the A/D converter. At the time of correcting the resistance value of the pull-up resistor R1, the switch SW1 is turned off and the switch SW2 is turned on, and the voltage at the connection point between the switch SW2 and the reference resistor is inputted to channel CHref of the A/D converter. This resistance value measuring device can figure out the resistance value of the thermistor highly accurately by calculating the voltage inputted to channel CH1 and the voltage inputted to channel CHref even if the resistance value of the pull-up resistor R1 fluctuates or temperature characteristics cause the resistance value to vary (see the Abstract).

### CITATION LIST

### Patent Literature

Patent Literature 1: JA-No. 2005-3596

### SUMMARY OF INVENTION

### Technical Problem

According to the background art described in Patent Literature 1, the pull-up resistor R1 (fixed resistor) connected in series to the thermistor by turning-on of the switch SW1 can be integrated into an integrated circuit. However, the reference resistor is not integrated into the integrated circuit, and its integration into any integrated circuit was difficult. The turning-on resistances of the switches SW1 and SW2, which are to be connected in series to the pull-up resistor R1 by changing over the thermistor and the reference resistor should be sufficiently lower than the resistance of the thermistor, and this invites an increase in the integrated circuit size. Especially, when a thermistor is used, the resistance is lower at a high temperature by about a two-digit factor than at normal temperature. For this reason, when use at a high temperature is considered, the size of the change-over switch should be sufficiently large, and the turning-on resistance should be sufficiently low. Furthermore, where the change-over switch is configured of a semiconductor switch, the turning-on resistance of the change-over switch increases at a high temperature. These variations of the turning-on resistance may cause an error to occur in measuring the resistance value of the thermistor.

For instance, an intake air temperature sensor can be configured of the thermistor and the pull-up resistor (fixed resistor) mentioned above. Whereas the thermistor in this case is used as a temperature sensing element, the usable temperature sensing element is not limited to a thermistor, but any element whose resistance value would vary with temperature can be used.

An object of the present invention is to integrate the fixed resistor to be connected in series to the temperature sensing element into an integrated circuit and to make dispensable the reference resistor and the change-over switch for connecting the fixed resistor to this reference resistor thereby to provide a more compact and highly accurate intake air temperature sensor.

### Solution to Problem

To solve the problem described above, an intake air temperature sensor according to the present invention has a temperature sensing element whose resistance value varies with the intake temperature; an integrated circuit that processes signals of the temperature sensing element; a resistive element integrated into the integrated circuit and connected in series to the temperature sensing element; and a writable memory that stores information regarding the resistance value of the resistive element, and the object is achieved by correcting signals detected by the temperature sensing element on the basis of the information stored in the writable memory. At this time, it is recommended to correct the curvature of the characteristics curve of signals detected by the temperature sensing element.

### Advantageous Effects of Invention

According to the present invention, it is possible to correct fluctuations of the resistance value of the resistive element integrated into the integrated circuit and connected in series to the temperature sensing element, and thereby to eliminate the need to provide a reference resistor for correcting the resistance value of the resistive element. As a result, it is possible to provide a compact and highly accurate intake air temperature sensor in which a resistive element is integrated into an integrated circuit.

Other problems, configurative aspects and advantageous effects will become more apparent from the following description of embodiments.

### BRIEF DESCRIPTION OF DRAWINGS

FIG. 1 is a diagram showing the configuration of an intake air temperature sensor, which is a first embodiment of the present invention.

FIG. 2 is a diagram showing the relationship between the intake temperature and Vsen/Vref.

FIG. 3 is a diagram showing the input/output characteristics of a bending correction processing 6.

FIG. 4 is a diagram showing the configuration of a sensor device, which is a second embodiment of the present invention.

FIG. 5 is a diagram showing the input/output characteristics of the bending correction processing 6 and of a linearization processing 8.

FIG. 6 is a diagram showing the configuration of a sensor device, which is a third embodiment of the present invention.

FIG. 7 is a diagram showing the pattern of a resistive element 3.

FIG. 8 is a diagram showing the configuration of an air flow measurement device using the intake air temperature sensor of the third embodiment as an example of sensor device.

FIG. 9 is a detailed diagram showing in detail the configuration of a flow rate detecting unit composed of an air flow rate detecting element 17 and an air flow rate signal adjusting unit 18.

### DESCRIPTION OF EMBODIMENTS

Embodiments of the present invention will be described below with reference to drawings.

### First Embodiment

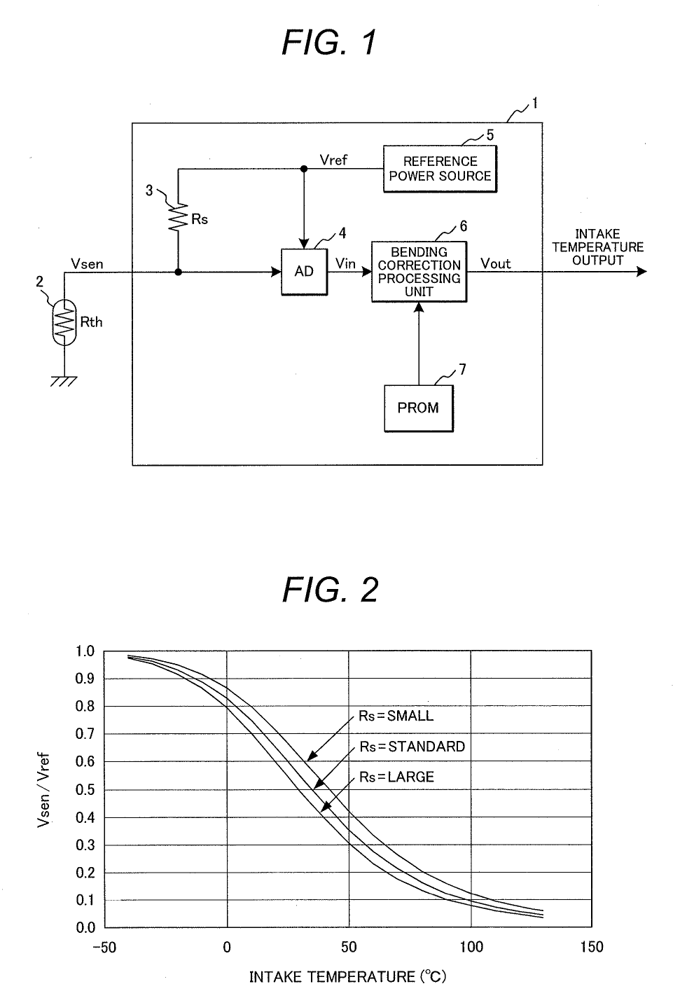

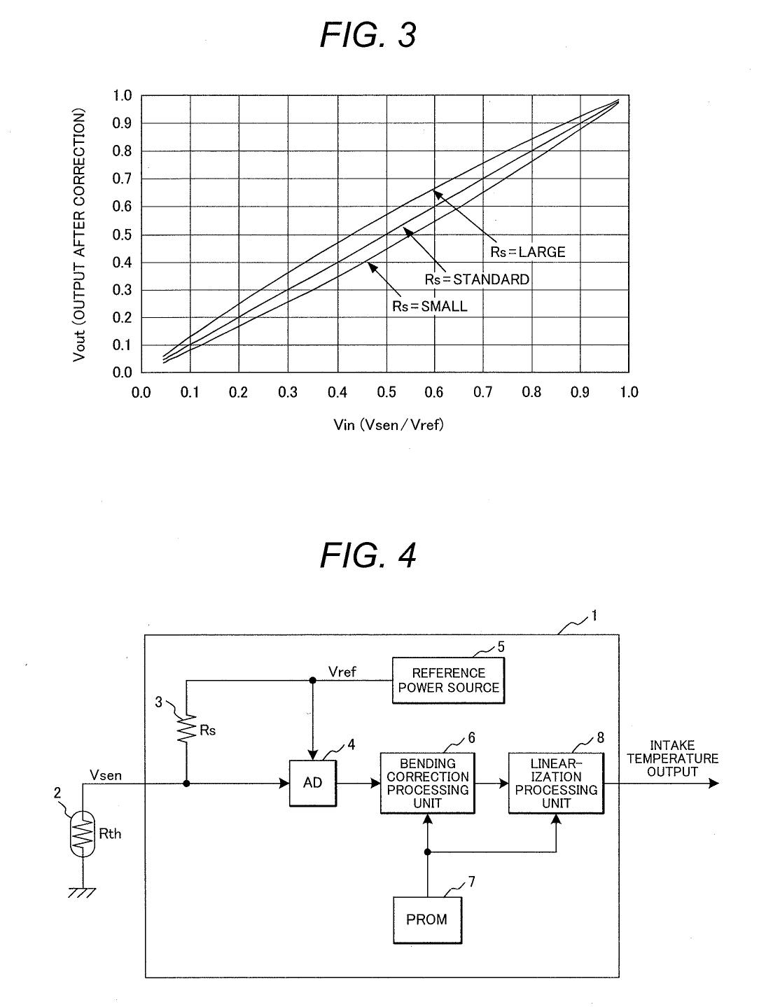

First, an intake air temperature sensor which is a first embodiment of the present invention will be described with reference to FIGS. 1 through 3. FIG. 1 is a diagram showing the configuration of the intake air temperature sensor in this embodiment. FIG. 2 is a diagram showing the relationship between the intake temperature and Vsen/Vref. FIG. 3 is a diagram showing the input/output characteristics of a bending correction processing unit 6.

The intake air temperature sensor in this embodiment is configured of a temperature sensing element 2 whose resistance value varies with the intake temperature; an integrated circuit 1 that processes signals of the temperature sensing element 2; a resistive element 3 connected in series to the temperature sensing element 2 and integrated into the integrated circuit 1; an AD converter 4 that subjects signals detected by the temperature sensing element 2 (the end-to-end voltage of the temperature sensing element 2) to analog-to-digital conversion; a reference power source 5 that supplies a reference voltage Vref to the resistive element 3 and the AD converter 4; a writable memory 7 that stores information corresponding to the resistance value of the resistive element 3; and a bending correction processing unit 6 that subjects the output of the AD converter 4 to bending correction on the basis of information from the writable memory (PROM) 7 and outputs an intake temperature output. Whereas a thermistor, a platinum resistor or the like may be used as the temperature sensing element 2 whose resistance value varies with the intake temperature, the description of this embodiment will take up a thermistor as an example.

In this embodiment, the temperature sensing element 2 whose resistance value varies with the intake temperature and the resistive element 3 are connected in series, and the voltage Vref is supplied from the reference power source 5. At this time, whereas the ratio between the end-to-end voltage Vsen of the temperature sensing element 2 and Vref varies with the intake temperature as shown in FIG. 2, the characteristic (bending) varies under the influence of the resistance value Rs of the resistive element 3. In this embodiment, the voltage Vsen is digitized by the AD converter 4 that conducts analog-to-digital conversion with the voltage Vref as the reference voltage, and this digital value is subjected to bending correction in the curve shown in FIG. 3 on the basis of information from the writable memory 7. This bending correction is accomplished by the bending correction processing unit 6. The bending correction is intended to eliminate the influence of the resistance value Rs of the resistive element 3. The input/output characteristics of the bending correction processing unit 6 (characteristics shown in FIG. 3) can be represented by:

Vout=Rs×Vin/{Rr+Vin×(Rs−Rr)} Formula (1)

where Vin is the input, Vout is the output, Rr is the reference resistance value of the resistive element 3, and Rs is the actual resistance value of the resistive element 3, and can be easily calculated by digital arithmetic operation.

Namely, by storing the actual resistance value Rs of the resistive element 3 in the writable memory 7, it is made possible to eliminate variations of characteristics due to fluctuations of the resistive element 3 by calculating Formula (1) on the basis of this information.

When bending correction is to be performed by using Formula (1), the input/output characteristics of the bending correction processing unit 6 are as shown in FIG. 3; if Rs is greater than its standard value, correction to give a curve a convex upward is performed in the input/output range of signals. In contrast, if Rs is smaller than the standard value, correction to give a curve a convex downward is performed in the input/output range of signals.

As shown in FIG. 3, the input/output characteristics of the bending correction processing unit 6 form a curve when Rs deviates from the standard value, deviating from the straight line formed when Rs is at the standard value. Namely, with these input/output characteristics, the bending correction processing unit 6 corrects, correspondingly to the extent of fluctuations from the standard value in Rs, the curvature of the characteristics curve that the output signal of the temperature sensing element 2 has with respect to the intake temperature. Even if Rs has fluctuations, coincidence with the characteristics curve of the standard value can be achieved by correcting the curvature of the characteristics curve.

Calculation of Formula (1) can also be done by utilizing a map. Further, though a PROM is used as the writable memory 7, the choice is not limited to a PROM, but any writable memory can be used.

### Second Embodiment

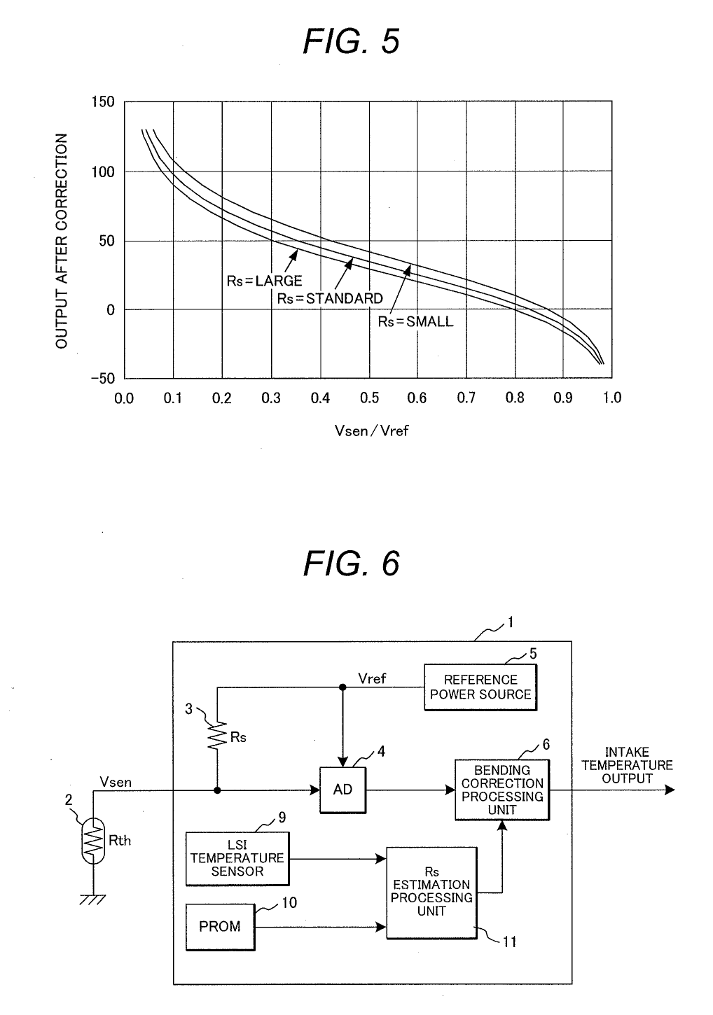

Next, a sensor device, which is a second embodiment of the present invention, will be described with reference to FIGS. 4 and 5. FIG. 4 is a diagram showing the configuration of an intake air temperature sensor in this embodiment. FIG. 5 is a diagram showing the input/output characteristics of the bending correction processing unit 6 and of a linearization processing unit 8.

The intake air temperature sensor of this embodiment, though configured in basically the same way as the intake air temperature sensor of the first embodiment, is improved in the following respects. The same aspects of configuration as in the first embodiment are denoted by respectively the same reference signs, and their description will be dispensed with.

In this embodiment, by providing the linearization processing unit 8 after the bending correction processing unit 6, the non-linear characteristics relative to the intake temperature shown in FIG. 2 are linearized. When the resistance value Rs of the resistive element 3 varies, the input/output characteristics of the linearization processing unit 8 vary as shown in FIG. 5. When a thermistor is used as the temperature sensing element 2, as the characteristics of the thermistor constitute an exponential function, the linearization processing unit 8 uses map processing. The map used in this map processing represents the relationship between the inputs and the outputs of the linearization processing unit 8. Where map processing is used, extremely complex processing is needed because the map has to be altered with variations in the resistance value Rs (resistance variations with fluctuations of things and temperature variations). However, by correcting the curvature due to fluctuations of the resistive element 3 with the bending correction processing unit 6 in advance as in this embodiment, the linearization processing unit 8 can be realized by simple map calculation.

The map for use in map processing is stored in advance in the writable memory 7.

### Third Embodiment

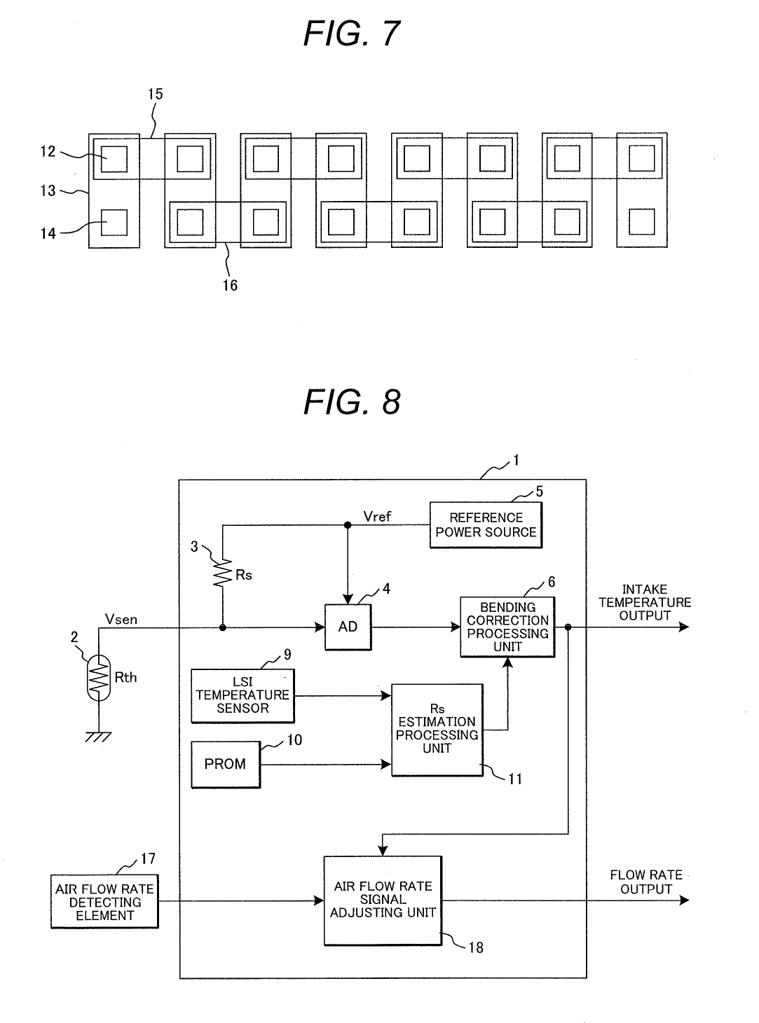

Next, an intake air temperature sensor, which is a third embodiment of the present invention will be described with reference to FIGS. 6 and 7. FIG. 6 is a diagram showing the configuration of an intake air temperature sensor, which is the third embodiment of the invention. FIG. 7 is a diagram showing the pattern of the resistive element 3.

The intake air temperature sensor of this embodiment, though configured in basically the same way as the intake air temperature sensor of the first embodiment, is improved in the following respects. The same aspects of configuration as in other embodiments are denoted by respectively the same reference signs, and their description will be dispensed with.

This embodiment is provided with an integrated circuit temperature sensor (LSI temperature sensor) 9 for detecting the temperature of the integrated circuit 1; a writable memory 10 that stores information corresponding to the resistance value of the resistive element 3 and the temperature coefficient of resistance; and a resistance value estimating unit (Rs estimating unit) 11 that estimates the resistance value of the resistive element 3 on the basis of information stored in the integrated circuit temperature sensor 9 and the writable memory 10. The integrated circuit temperature sensor 9 and the resistive element 3 are arranged in proximity to each other to make the temperatures of the integrated circuit temperature sensor 9 and the resistive element 3 are substantially equal. In this case, that “the temperatures of the integrated circuit temperature sensor 9 and the resistive element 3 substantially equal” means that the temperature of the resistive element 3 can be detected by the integrated circuit temperature sensor 9 so that the resistance value of the resistive element 3 estimated by using the temperature detected by the integrated circuit temperature sensor 9 can be kept within a tolerable error range permitting use for bending correction by the bending correction processing unit 6.

Generally, a resistive element in an integrated circuit has a temperature coefficient of resistance of 1000 to 3000 ppm/° C. For this reason, as the temperature of the resistive element 3 may vary by 100° C. or even more with a change in ambient temperature or self-heating of the integrated circuit 1, the resistance value of the resistive element 3 may vary by 10 to 30%. This would give rise to errors in outputs of the intake air temperature sensor. On account of this circumstance, in this embodiment, the writable memory 10 is caused to store information corresponding to the resistance value Rs of the resistive element 3 and to a temperature coefficient of resistance TCR, and the resistance value estimating unit processing 11 estimates the resistance value Rs of the resistive element 3 on the basis of this information. And implementation of bending correction by the bending correction processing unit 6 using the estimated resistance value Rs is intended to eliminate the influence of the resistance value Rs of the resistive element 3. The output Rs of the resistance value estimation processing unit 11 can be represented by

Rs=Rs0×{1+TCR×TIsi} Formula (2)

where Rs0 is the resistance value of the resistive element 3 at 0° C., TCR is the temperature coefficient of resistance of the resistive element 3, and TIsi is the output of the integrated circuit temperature sensor 9, and can be easily calculated by digital arithmetic operation.

Namely, by storing the resistance value Rs0 of the resistive element 3 at 0° C. and the temperature coefficient of resistance TCR in the writable memory 10, it is made possible to eliminate variations of characteristics of the intake air temperature sensor due to fluctuations of the resistive element 3 and resistance variations due to temperature variations by calculating Formula (2) on the basis of this information. This enables a fixed resistor and the like connected in series to the intake air temperature sensing element to be integrated into an integrated circuit.

Further in this embodiment, the pattern of the resistive element 3 is as shown in FIG. 7. The resistive element 3 is provided with a plurality of unit resistance patterns each including a diffusion area 13 and contacts 12 and 14, and configured by connecting these unit resistance patterns with aluminum wirings 15 and 16. Whereas the temperature coefficient of resistance of the diffusion area is 100 to 3000 ppm/° C., the temperature coefficient of resistance of the contacts has a negative value of −3000 ppm/° C. For this reason, a configuration of the resistive element 3 having a plurality of unit resistance patterns as in this embodiment can increase the influence of the contact resistance and decrease the temperature coefficient of resistance of the resistive element 3. As this can reduce temperature-dependent variations of the resistance value of the resistive element 3, the estimation accuracy of the resistance value estimation processing unit 11 can be enhanced, thereby making possible more accurate detection of the intake temperature.

### Fourth Embodiment

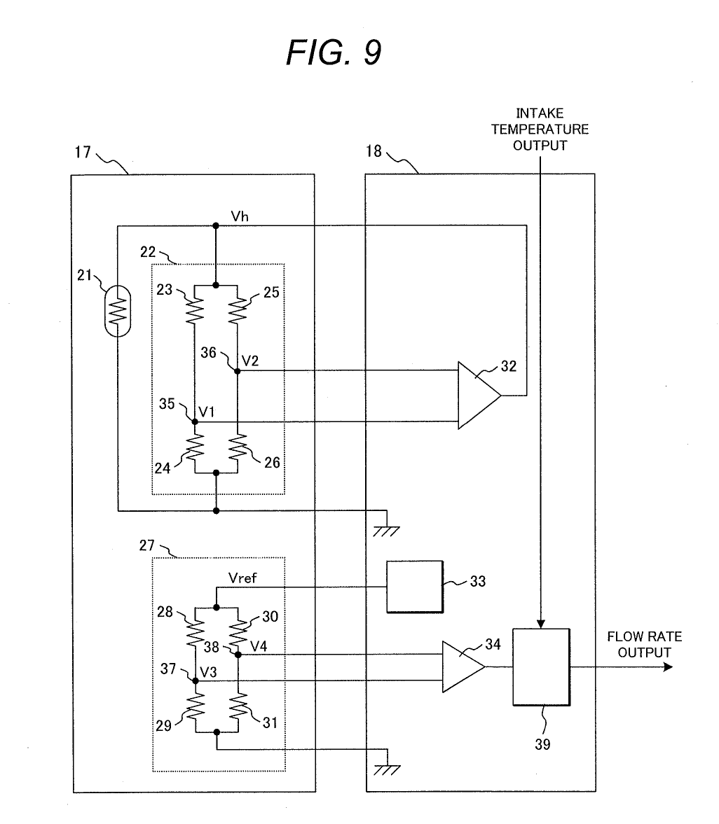

Next, as one embodiment of sensor device, an embodiment of air flow measurement device using the intake air temperature sensor of the third embodiment (fourth embodiment) will be described with reference to FIGS. 8 and 9. FIG. 8 is a diagram showing the configuration of the air flow measurement device in this embodiment. FIG. 9 is a detailed diagram showing in detail the configuration of a flow rate detecting unit composed of an air flow rate detecting element 17 and an air flow rate signal adjusting unit 18.

The sensor device of this embodiment is provided with an intake air temperature sensor configured in basically the same way as the intake air temperature sensor of the third embodiment. Further in this embodiment, to configure an air flow measurement device, the air flow rate detecting element 17 for detecting the flow rate of the intake air and the air flow rate signal adjusting unit 18 built (integrated) into the integrated circuit 1 to adjust (process) the output of the air flow rate detecting element 17 and supply a flow rate output are provided.

Though this embodiment uses the device of the third embodiment as the intake air temperature sensor, the intake air temperature sensor of the first or second embodiment may as well be used.

The air flow measurement device of this embodiment is a thermal measurement device that measures the air flow by heating a heat generating element (heat generation resistor) by subjecting it to heating control. It is necessary for a thermal type air flow measurement device to detect the temperature of the flowing air, and the air temperature is detected by using the intake air temperature sensor described with respect to the aforementioned embodiment. In this embodiment, air (in particular, intake air taken into an internal combustion engine) is the object of measurement, but it may as well be a thermal type fluid flow measurement device whose object of measurement is some other fluid. Also, even if it is a non-thermal type fluid flow measurement device, the fluid temperature can be accurately detected and, moreover, the device can be reduced in size by combined use of the intake air temperature sensor of any of the foregoing embodiments when detecting the temperature of fluid. In the following description, the air flow measurement device, the air flow rate signal adjusting unit 18 and the air flow rate detecting element 17 will be referred to as a flow measurement device, a flow rate signal adjusting unit 18 and a flow rate detecting element 17, respectively.

The flow rate detecting element 17 is configured of a heat generating element 21, a heater temperature detecting bridge circuit 22 composed of a heater temperature detecting resistor 23 whose resistance value varies with the temperature of the heat generating element 21 and fixed resistors 24, 25 and 26, temperature detecting resistors 28 and 31 arranged upstream of the heat generating element 21 in air flow direction and temperature detecting resistors 29 and 30 arranged downstream, and a temperature difference detecting bridge circuit 9 for detecting the temperature difference between the upstream and downstream of the heat generating element 21. Further, in the flow rate signal adjusting unit 18 integrated into the integrated circuit 1, a differential amplifier 32 that supplies a drive voltage Vh to a heat generating element 2 in response to the output of the heater temperature detecting bridge circuit 22 and a differential amplifier 34 that generates a flow rate output in response to the output of the temperature difference detecting bridge circuit 9 are arranged.

The differential amplifier 32 amplifies the voltage difference between the voltage V1 of the connecting part 35 of the heater temperature detecting resistor 23 and the fixed resistor 24 and the voltage V2 of the connecting part 36 of the fixed resistor 25 and the fixed resistor 26 and thereby generates the drive voltage Vh to the heat generating element 2. The differential amplifier 34 amplifies the voltage difference between the voltage V3 of the connecting part 37 of the temperature detecting resistor 28 and the temperature detecting resistor 29 and the voltage V4 of the connecting part 38 of the temperature detecting resistor 30 and the temperature detecting resistor 31 and thereby generates a flow rate output.

The flow rate signal adjusting unit 18 is provided with a flow rate signal processing unit 39, including an arithmetic unit, for performing correction or adjustment of the output of the differential amplifier 34. The correction and adjustment performed by the flow rate signal processing unit 39 include signal linearization processing and correction processing applied to various error factors. The detected flow rate signal may be affected by the intake temperature. Flow rate signals detected by using a heat generation resistor are particularly vulnerable to the influence of the intake temperature. In view of this circumstance, the intake temperature output of the intake air temperature sensor is inputted to the flow rate signal processing unit 39 and, after compensating and adjusting the output of the differential amplifier 34 for the influence of the intake temperature with the flow rate signal processing unit 39, the result is supplied as the flow rate output.

For the flow rate detecting element 17 using a heat generating element, besides the configuration described above, there also are elements in which the configuration of the heat generating element or the bridge circuit is altered, and a flow rate detecting element of some other configuration may as well be used.

As this embodiment has a very accurately adjusted intake temperature output signal, the air flow rate signal can be very accurately adjusted by using this intake temperature output signal.

According to any of the embodiments described above, there is no need to use a resistive element of particularly high accuracy as the resistive element to be connected in series to the temperature sensing element, and the resistive element can be integrated into the integrated circuit. No reference resistor for correcting the resistance value of the resistive element is needed either. In this way, a compact and highly accurate intake temperature sensor in which the resistive element is integrated into the integrated circuit can be provided.

The present invention is not limited to the embodiments described above, but may include various modifications. For instance, the embodiments are intended as cases for detailed description to make the present invention readily understandable, but they are not limited to full configurations. It is also possible to replace a part of the configuration of an embodiment with a part of the configuration of another embodiment, or it is possible to add to the configuration of one embodiment the configuration of another embodiment. Further, to, from or for a part of the configuration of any embodiment, an element of another configuration can be added, deleted or substituted, respectively. For instance, the linearization processing unit 8 described with reference to the second embodiment can be added to the third and fourth embodiments.

Also, the configurations, functions, processing units, processing means and so forth described above can be realized with hardware by, for instance, designing part or whole of them as an integrated circuit. Further, the configurations, functions and so forth described above can be realized with software by having a processor interpret and execute program for realizing their respective functions. Information for realizing the functions such as programs, tables and files can be placed in a recording device such as a memory, hard disk or an SSD (Solid State Drive), or a recording medium such as an IC card, an SD card or a DVD.

Further, the control lines and information lines referred to above are those necessary for the descriptive purpose, but not all the control lines and information lines in the product are referred to. For practical purposes, almost all the elements of configuration can be regarded as being connected to one another.

### REFERENCE SIGNS LIST

1 . . . Integrated circuit,
2 . . . Temperature sensing element,
3 . . . Resistive element,
4 . . . AD converter,
5 . . . Reference power source,
6 . . . Bending correction processing unit,
7 . . . Writable memory,
8 . . . Linearization processing unit,
9 . . . Integrated circuit temperature sensor,
10 . . . Writable memory,
11 . . . Resistance value estimation processing unit,
12 . . . Contact,
13 . . . Diffusion area,
14 . . . Contact,
15 . . . Aluminum wiring,
16 . . . Aluminum wiring,
17 . . . Air flow rate detecting element, and
18 . . . Air flow rate signal adjusting unit.

1. An intake air temperature sensor comprising:
a temperature sensing element whose resistance value varies with the intake temperature;
an integrated circuit electrically connected to the temperature sensing element;
a resistive element integrated into the integrated circuit and connected in series to the temperature sensing element;
a writable memory that stores corrective information corresponding to the resistance value of the resistive element; and
a correction processing unit that corrects, on the basis of corrective information stored in the writable memory, errors based on the resistance value of the resistive element contained in an output signal of the temperature sensing element.

2. The intake air temperature sensor according to claim 1,
wherein the correction processing unit corrects the curvature of the characteristics curve of the output signal of the temperature sensing element relative to the intake temperature.

3. The intake air temperature sensor according to claim 2, comprising
a linearization processing unit that stores linearizing information for linearizing the characteristics curve in the writable memory and linearizes the characteristics curve on the basis of the linearizing information stored in the writable memory.

4. The intake air temperature sensor according to claim 2, comprising
an integrated circuit temperature sensor for detecting the temperature of the integrated circuit and a resistance value estimation processing unit for estimating the resistance value of the resistive element from an output of the integrated circuit temperature sensor,
wherein the correction processing unit corrects the curvature of the characteristics curve on the basis of an output from the resistance value estimation processing unit.

5. The intake air temperature sensor according to claim 4,
wherein information corresponding to the temperature coefficient of resistance of the resistive element is stored in the writable memory.

6. The intake air temperature sensor according to claim 4,
wherein the integrated circuit temperature sensor is arranged in proximity to the resistive element so that the integrated circuit temperature sensor is arranged in a position where the temperature detected by the integrated circuit temperature sensor is substantially equal to the temperature of the resistive element.

7. The intake air temperature sensor according to claim 2,
wherein the resistive element is configured of a plurality of unit resistors each configured of a diffusion area and a contact being connected in series.

8. A flow measurement device that subjects a heat generation resistor to heating control and detects a flow rate of fluid flowing in the surroundings of the heat generation resistor, comprising:
the intake air temperature sensor according to claim 1; and
an air flow rate signal adjusting unit that adjusts the flow rate output by using an output of the intake air temperature sensor.
